(19) United States
(12) Patent Application Publication
(10) Pub. No.: US 2010/0314328 A1
(43) Pub. Date: Dec. 16, 2010

(54) Method and Apparatus for Maintaining Pool Water Levels Utilizing Fluid Controllers and Skimmer Baskets

(76) Inventor: John Joseph Bizon, Marco Island, FL (US)

Correspondence Address: John Joseph Bizon, 951 Olive Ct., Marco Island, FL, 34145, US

(21) Appl. No.: 12/781,626

(22) Filed: May 17, 2010

Related U.S. Application Data
(60) Provisional application No. 61/186,868, filed on Jun. 14, 2009.

(51) Int. Cl. E04H 4/16; F15D 1/00

(52) U.S. Cl. 210/744; 137/1

(57) ABSTRACT

Various methods and apparatus are described for pool water replenishment to desired levels. One embodiment (FIG. 1) depicts a skimmer basket chamber (22) with a skimmer basket (14) inside, designed with a latitudinal mounting plate (26/28) for supporting a fluid controller such as a toilet fill valve (10). The replenishment of pool water to desired levels is accomplished by making adjustments to the fluid controller, which opens when water levels become sufficiently low allowing water to be added from a fluid supply conduit (18) that is routed through a lateral water overflow tube (17) and attached to a reliable water supply source. All embodiments have distinct advantages over prior art that are achieved by utilizing simple and efficient methods and apparatus, designed to provide convenient, safe, reliable, low cost and inconspicuous installation and operation. Many ramifications are described for the mounting of fluid controllers and the routing of water supply conduit (18).

### CROSS-REFERENCE TO RELATED APPLICATIONS

This application claims benefits of provisional patent application Ser. No. 61/186,868, filed 2009 Jun. 14 by the present inventor.

### FEDERALLY SPONSORED RESEARCH

Not Applicable

### SEQUENCE LISTING OR PROGRAM

Not Applicable

### BACKGROUND

1. Field

This application relates to apparatus such as fluid controllers, pool components and compartments, skimmer baskets, fluid conduit connectors, securing mechanisms, and the like, utilized together with innovative methods to create water replenishment systems for pools and spas.

In all aspects and contexts of this application, the words fluid and water shall have equivalent meanings and shall be used interchangeably. Likewise, the words fluid controller(s), fluid control device(s), water control valve(s), toilet fill valve(s) and the like shall have equivalent meanings and be used interchangeably. Also, for the purposes of this writing, pools and spas will fall into one of two categories, differentiated by the build method utilized during construction. The two categories shall be referred to as either built-in pools and spas or kit pools and spas. Built-in pools and spas, whether constructed above or below-ground, shall be defined to be those that are integrally built into a permanent surrounding pool deck structure, so that disassembly is very difficult without performing some level of demolition of the primary pool basin and surrounding pool deck structure. Kit pools and spas, on the other hand, can be assembled, disassembled, and relocated generally without requiring the demolition of the primary pool basin and surrounding pool deck structure, if so equipped. While the embodiments of this writing will generally describe their application to built-in pools and spas, it is not intended to exclude the application of the embodiments of this writing to kit pools and spas in any way whatsoever. References to the terms pools or spas individually in this writing shall have the same meaning as the terms pools and spas referenced together, unless otherwise noted.

2. Prior Art

Swimming pools, spas, hot tubs, ponds and other sufficiently similar pool-like reservoirs, further to be called “pools” or “swimming pools”, frequently require the addition of water due to losses from evaporation, leakage, splashing, and other such causes. Expensive water re-circulation equipment can become damaged if pool water levels drop sufficiently low, allowing for air to be drawn into the pool's plumbing system thereby increasing the risk of pump motors burning out due to excessive air cavitation. Basic water replenishment to desired levels is generally accomplished manually using a garden hose and a watchful eye to determine when to refill and when to stop so as not to waste water by over-filling. Forgetfulness, vacation absence, and the like by humans responsible for maintaining proper pool water levels, can increase the risk of equipment damage due to sufficiently low water levels.

The need for automated pool water replenishment systems that are able to maintain a pre-determined water level is well known in prior art. The simplest automated prior art systems are mechanical (non-electrical) and are often referred to by different names such as pool levelers, water levelers, auto levelers, pool fillers, auto fillers, and the like. While different, they essentially perform similar water replenishment functions in different ways. Generally, automated prior art systems fall into two categories: 1) permanently installed mechanical water levelers, primarily built-in as a part of new construction, and 2) portable mechanical water levelers designed for use in existing pools, not previously equipped with permanently installed water levelers. Both versions of prior art have limitations as described below.

Permanently installed mechanical pool water leveling systems such as U.S. Pat. Nos. 6,158,064 to Downs (2000), 6,035,879 to Campbell et al. (2000), 7,003,817 to Pansini (2006), and 0,089,505 to Peterson (2007) generally involve the additional of a unique pool compartment, specifically designed and constructed for housing a mechanical water control valve, for providing a point of connection to a permanent water supply line, and for providing a special communication conduit to pool water. The unique pool compartment, whether built on-site or purchased as a self-contained component, must be installed by a pool builder or contractor during initial pool construction, involving the use of various specialized building tradesmen. Consequently, the incremental cost of this type of mechanical pool water leveling system can become very cost prohibitive to new home buyers, as they attempt to rationalize and minimize the overall cost of the home and pool purchase. For this reason, mechanical pool water leveling systems are often omitted. Once the pool has been constructed, a mechanical pool water-leveling retrofit system is generally no longer practical due to the high cost of breaking up and replacing portions of the pool deck, adding a plumbing supply line and components, and fabricating or purchasing the unique pool compartment, previously described above. The high cost of a post-construction, pool water-leveling retrofit system, along with risk of poor execution and appearance, often eliminates this option as an acceptable solution.

Other forms of prior art involve mechanical portable water levelers that offer limited post construction pool water leveling solutions. While mechanical portable water levelers adequately replenishment water when used, at least one manufacturer does not recommend their product's continuous use as part of their safety disclaimer. In addition to safety concerns, significant appearance, convenience, stability and mounting concerns also exist and will be detailed further. Mechanical portable water levelers are described in prior art such as U.S. Pat. Nos. 4,342,125 to Hodge (1982), 4,592,098 to Magnes (1986), 4,655,243 to Keller (1987), 5,203,038 to Gibbs (1993), 5,836,022 to Busenga (1998), 6,006,605 to Sulollari (1999), 0,205,885 to Gardner (2003) and 6,826,787 to Gregory (2004). Generally, prior art overhangs the pool edge, while either resting on the pool deck, or attaching in a semi-fixed manner to the pool deck, to the pool ladder, or the like. Prior art utilizes a pressurized garden hose that lays on the pool deck and connects to a water supply valve, which remains constantly in the open position while in use. This creates two serious safety concerns: Safety #1—the garden hose and portable water leveler laying on the pool deck impose sufficiently large obstacles, and trip and fall hazards to humans involved with using the pool deck in a normal manner, especially creating unsafe conditions for children and senior citizens. Recognizing the risks, some portable pool leveler product manufacturers publish warnings and disclaimers, which they include in their product package. Their warnings and disclaimers advise consumers to limit their product's use to only when humans are not using the pool or pool deck, such as while they are away from their home and pool, or while they on vacation. This type of prior art is truly an inconvenience since: a) manufacturers warn that the art is not safe for use when humans are present, b) the art must be disconnected and stored when not in use, c) the art therefore cannot remain constantly vigilant, monitoring and maintaining pool water levels, unless humans are not around, and d) the art must be brought out of storage and setup for use each time that the water level is low, as long as humans are around the pool area and at risk of a trip and fall hazard. Safety #2—the garden hose as a water supply conduit of the aforementioned art can be subjected to continuously high water working-pressure when in use. For example, conventional garden hoses are stressed to the limits when continuously high water pressure (water pressures often in excess of seventy-five pounds per square inch) is present, and when repeated exposure to intense sunlight and ultraviolet radiation combine to soften and slowly degrade the garden hose material. The conditions described are commonly found in the Deep South of the US, and in the tropical and semi-tropical climes of the Northern and Southern Hemispheres. Such factors create a perfect environment for the garden hose to burst unexpectedly, potentially generating very high consumer water bills, and wasting very large amounts of water, especially when the pool is unattended.

Most mechanical portable water levelers of prior art overhang the pool edge, and must be filled with stones for ballast and stability per the manufacturer's instructions. Other forms of prior art must to be bolted or otherwise secured to the pool, pool deck, or pool ladder in order to function properly. This is a true inconvenience for the consumer since the pool leveler and garden hose must be removed from the pool in order to avoid contact with swimmers, in order to maintain safe operation around pool deck users, and to prevent the pool leveler sensors from inadvertently turning the pool leveler on and off repeatedly due to wave action.

While not found commercially, one final form of mechanical prior art is described in U.S. Pat. No. 4,706,310 to Magnes (1987) that involves the use of a fluid controller mounted to the underside of a pool skimmer access cover. While this solution offers advantages not found in previously described prior art, the upside down mounting position of the fluid controller prohibits the use of today's extremely popular and very economical toilet fill valves that are available from many manufacturers worldwide. Prior art of this type is comparatively less economical and has not seen wide acceptance.

### ADVANTAGES

The need for a better pool water leveling system that offers simplicity, effectiveness and low cost is evident. Of particularly benefit to consumers will be found in the devices, which: 1) substantially resolve the above mentioned prior art issues, 2) operates safely and automatically, while continuously remaining vigilant in its operation, and 3) can be manufactured and installed in a cost effective manner as compared to the devices of prior art. The desirable consumer benefits mentioned above is in fact the advantages of the method and apparatus to be described in the specifications and claims of the embodiments that follow.

In brief, the method that follows describes many acceptable embodiments, all of which utilize many existing pool components, such as the skimmer basket, the skimmer compartment, the overflow tube if available, and the like, which by design are in communication with other pool components and with pool water. The method describes the use of fluid control devices, some more commonly known as toilet fill valves, which are proven reliable, already possess anti-siphoning features, are economical, and are readily available in the marketplace. The method describes how to use toilet fill valves and skimmer baskets with other devices in very unique ways. The method describes the use of many acceptable fluid or water supply conduit; especially desirable are those possessing small cross-sectional area, very high working-pressure capability, and ultraviolet radiation resistance. The method describes several water supply conduits, also known as water supply connector embodiments, some of which involve newly designed connectors that reduce the need for a multiplicity of parts for reduced cost. Some of the newly designed connector embodiments effectively combine many parts into one, which substantially reduce: the manufacturing complexity, the overall package size, the cost of labor and materials, and ultimately the price to the consumer. While pool and spa skimmer basket sizes and shapes vary widely, some skimmer baskets are quite small. The use of newly designed connector embodiments with smaller sized diameters, allow for proper fitment into very small skimmer baskets, making the methods useful to wider application. The method also describes various embodiments providing for water supply conduit routing in order to connect the devices and components mentioned above to a pressurized water supply source. Some embodiments utilize existing pool water return lines, pool overflow tubes when such are available, and other relatively inconspicuous routing methodologies for water supply conduit. Sufficient water supply routing methods are identified as needed to accommodate a wide array of differing pool designs and pool component availability. The embodiments represent breakthrough solutions to the many disadvantages of prior art. Taken together, the methods and embodiments to be described later in detail truly represent better approaches for the safe, low cost, convenient, inconspicuous, automatic, and continuous operation and replenishment of pool water to predetermined levels.

### SUMMARY

In accordance with the embodiments and specifications being disclosed, several methods and apparatus are described for maintaining predetermined water levels within a pool, comprising: 1) a toilet fill valve or other such device for fluid control, 2) pool components such as a pool compartment and pool compartment members together having means for mounting the toilet fill valve and for communicating with pool water, and 3) providing fluid supply conduit for fluid transmission.

### DRAWINGS

### Figures

The objects and advantages of the embodiments will become apparent from the following description when read in conjunction with the accompanying drawings. For simplicity, like reference numerals within the several drawings shown designate functionally similar components, which may or may not be dimensionally identical. Closely related drawings have the same reference number but different alphabetic suffixes. The components in the drawings are not necessarily to scale. Drawing descriptions follow:

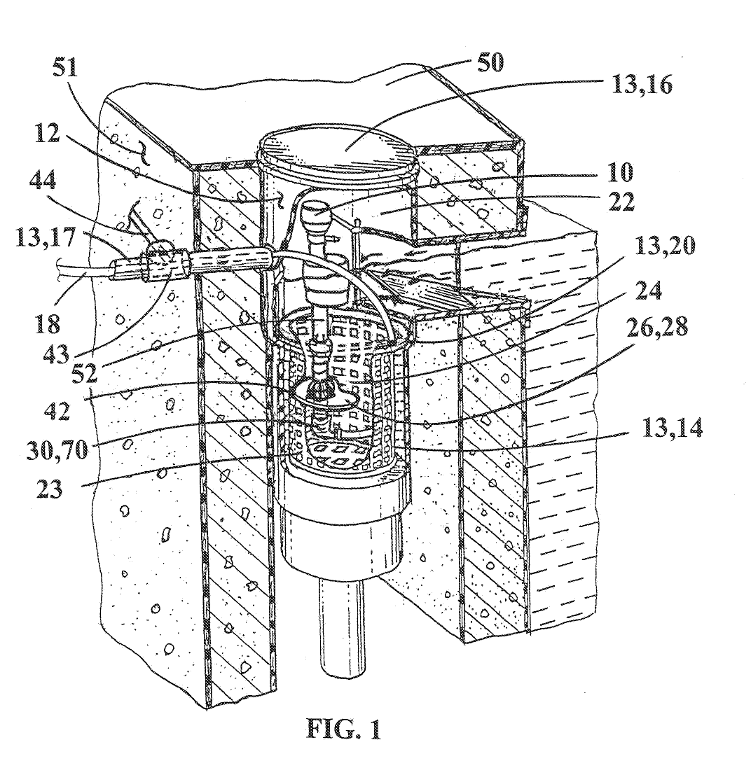

FIG. 1 is a perspective cutaway view of a pool compartment and pool compartment members interfacing with apparatus consisting of a fluid controller and a skimmer basket with a circumferential sidewall modified to accept a latitudinal mounting plate;

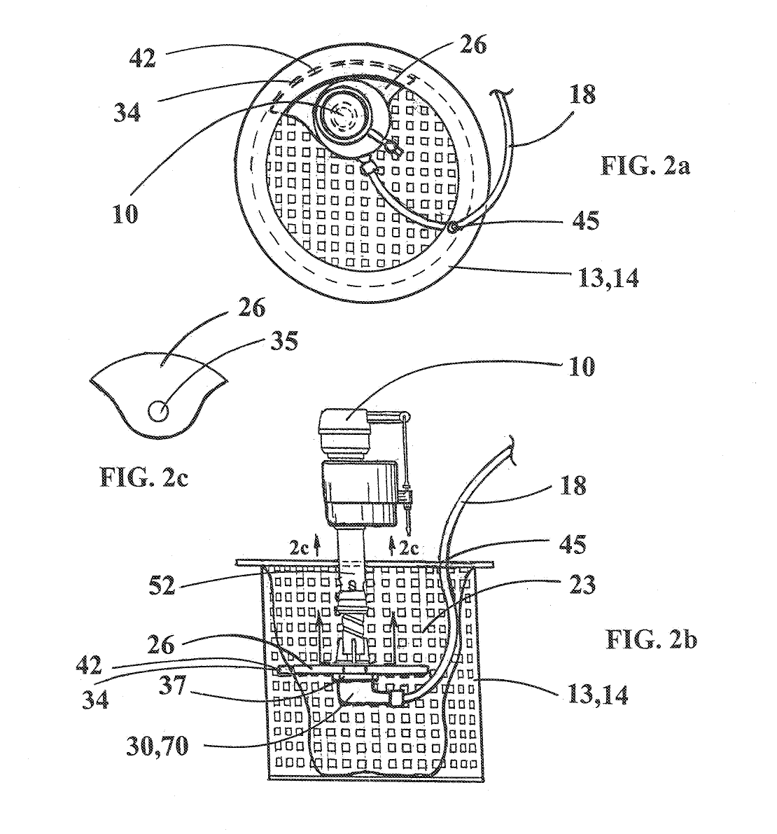

FIG. 2a is a top view showing an embodiment of FIG. 1 consisting of a skimmer basket that is modified with a mounting location cut-in or molded in-place into the circumferential sidewall, to which the latitudinal mounting plate is assembled, and to which the fluid controller is mounted;

FIG. 2b is a front view showing the same embodiment as in FIG. 2a;

FIG. 2c is a top view taken of line 2c-2c of FIG. 2b showing the latitudinal mounting plate component;

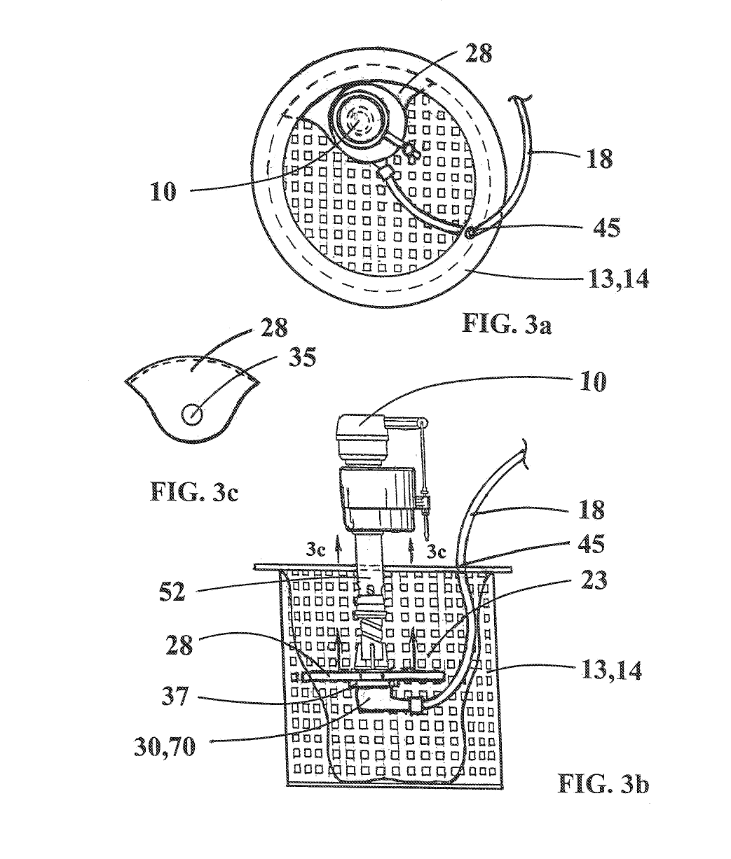

FIG. 3a is a top view showing an alternative embodiment of FIG. 1 consisting of a skimmer basket that is modified by integrating a latitudinal mounting plate (molded in-place) into the circumferential sidewall, to which the fluid controller is mounted;

FIG. 3b is a front view showing the same embodiment as in FIG. 3a;

FIG. 3c is a top view taken of line 3c-3c of FIG. 3b showing the latitudinal mounting plate sectioned and removed from the circumferential sidewall of an alternative skimmer basket modification into which it is integrally molded;

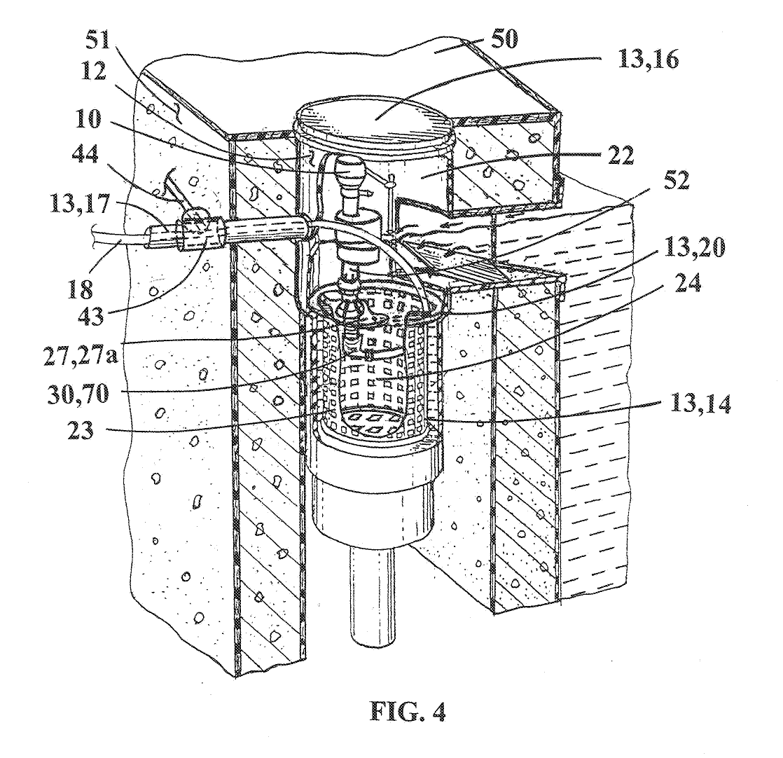

FIG. 4 is a perspective cutaway view of a pool compartment and pool compartment members interfacing with apparatus consisting of a fluid controller and a skimmer basket with a top edge modified to accept a latitudinal mounting plate;

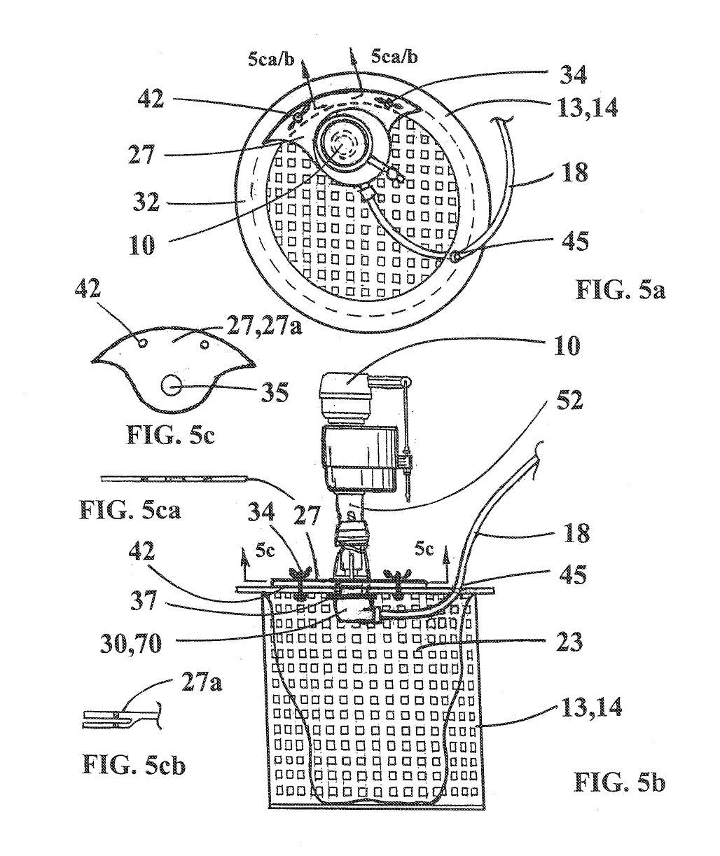

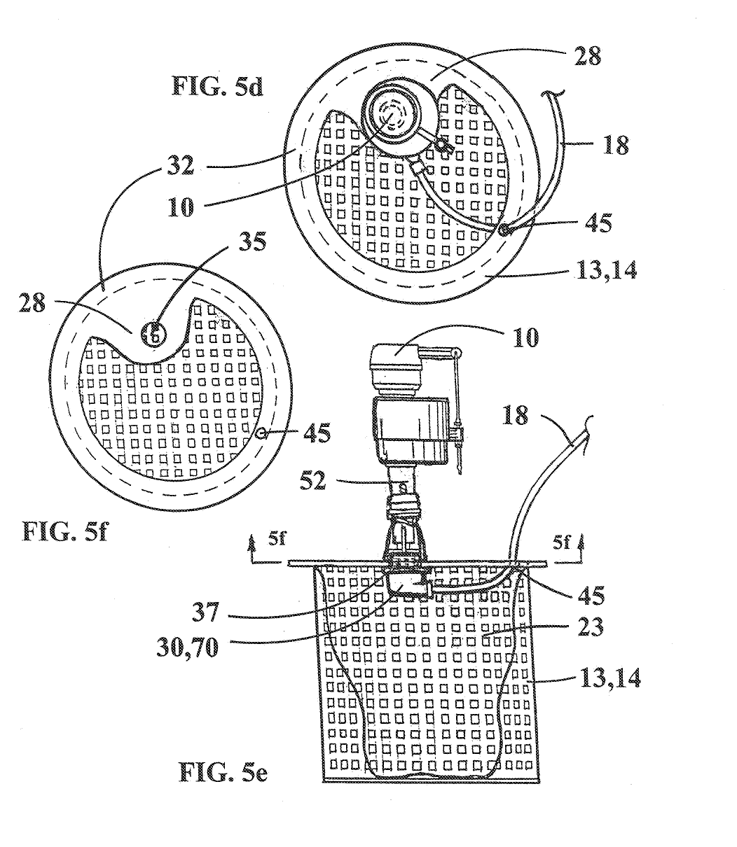

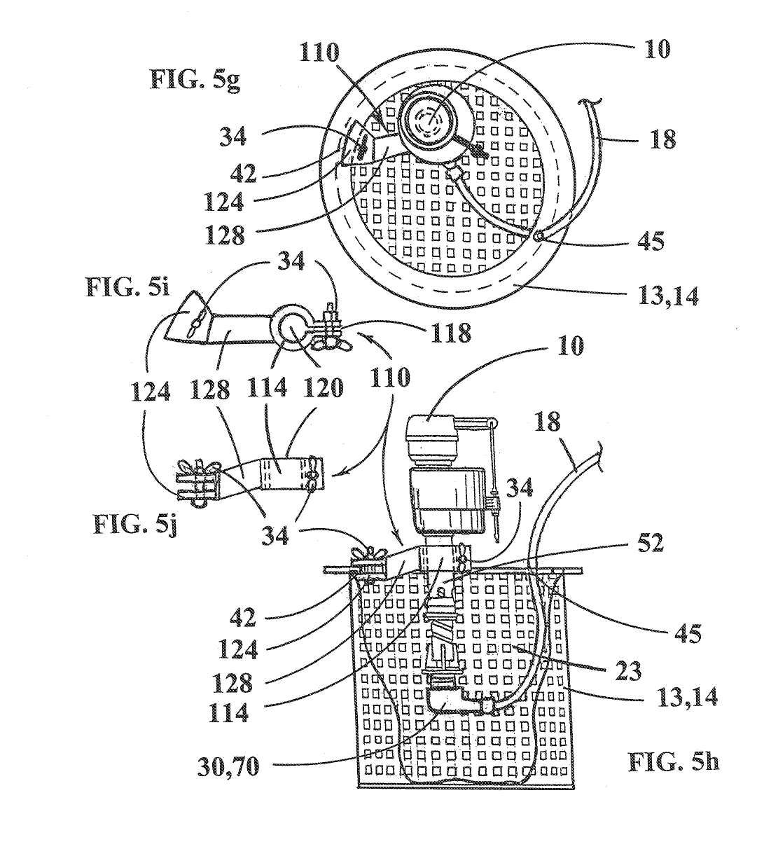

FIG. 5a is a top view showing an embodiment of FIG. 4 consisting of the fluid controller and the skimmer basket with a latitudinal mounting plate affixed to a top edge of the skimmer basket;

FIG. 5b is a front view showing the same embodiment as in FIG. 5a;

FIG. 5c is a top view taken of line 5c-5c of FIG. 5b showing the latitudinal mounting plate component;

FIG. 5ca is a side view taken of line 5ca-5ca of FIG. 5a showing the latitudinal mounting plate component with a single plane edge;

FIG. 5cb is a side view taken of line 5cb-5cb of FIG. 5a showing an alternate latitudinal mounting plate component section with a fork edge;

FIG. 5d is a top view showing an alternative embodiment of FIG. 4 consisting of the fluid controller and a skimmer basket modified with a latitudinal mounting plate integrally molded in-place into the top edge;

FIG. 5e is a front view showing the same embodiment as in FIG. 5d;

FIG. 5f is a top view taken of line 5f-5f of FIG. 5e showing the latitudinal mounting plate with latitudinal mounting hole integrated into the top edge of the alternative skimmer basket modification;

FIG. 5g is a top view showing an alternative embodiment of FIG. 4 consisting of the fluid controller and the skimmer basket connected together by way of a holder assembly that has capability of mounting and positioning the fluid controller;

FIG. 5h is a front view showing the same embodiment as in FIG. 5g;

FIG. 5i is a top view of the holder assembly, shown separately from the combined assembly of FIGS. 5g and 5h, having a clamping end and a connecting end;

FIG. 5j is a side view showing the same embodiment as in FIG. 5i;

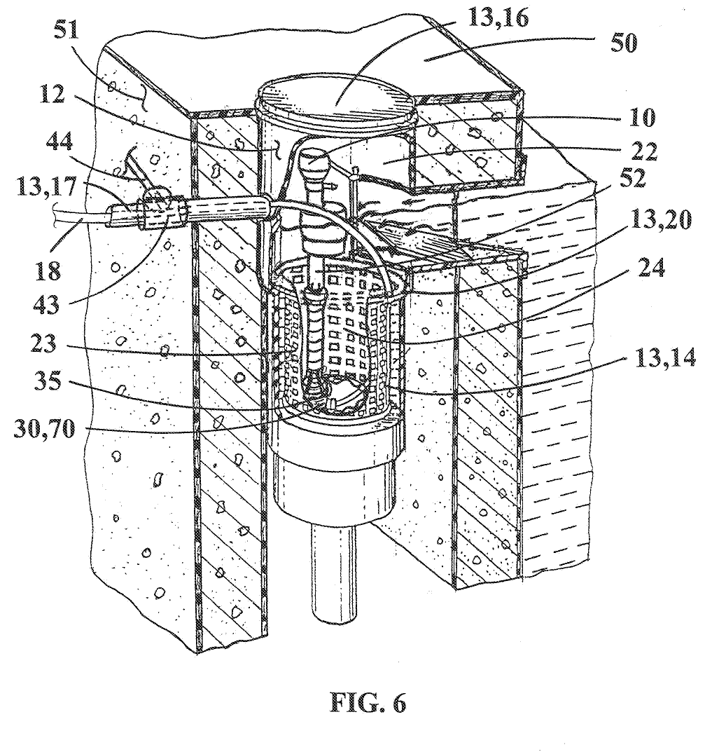

FIG. 6 is a perspective cutaway view of a pool compartment and pool compartment members interfacing with apparatus consisting of a fluid controller and a skimmer basket with a basket floor modified to create a latitudinal mounting hole;

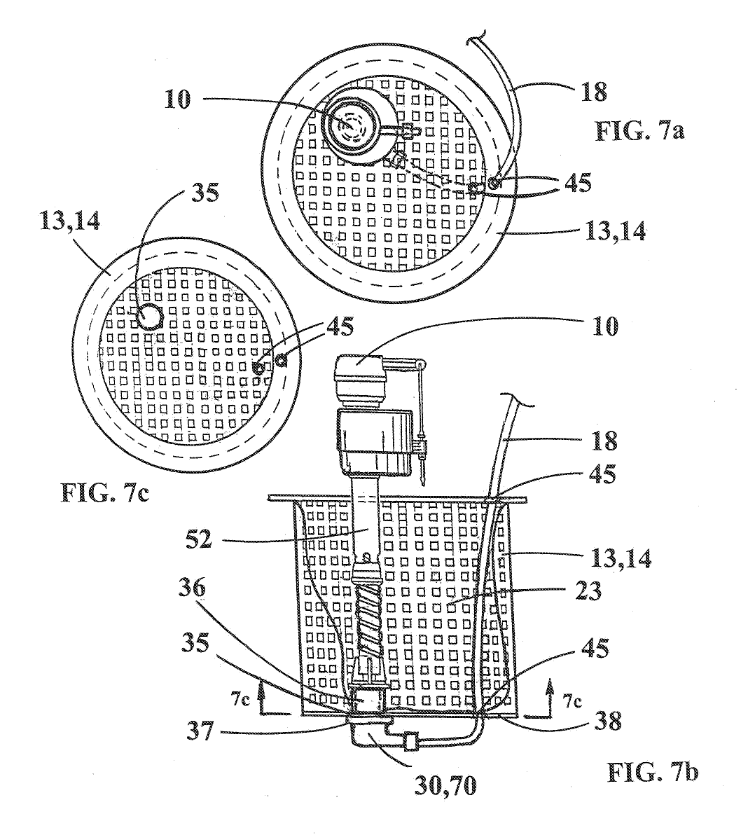

FIG. 7a is a top view showing an embodiment of FIG. 6 consisting of the fluid controller and the skimmer basket modified with a latitudinal mounting hole cut-in or molded in-place into the skimmer basket floor;

FIG. 7b is a front view showing the same embodiment as in FIG. 7a;

FIG. 7c is a top view taken of line 7c-7c of FIG. 7b showing the latitudinal mounting hole cut-in or molded in-place into the skimmer basket floor;

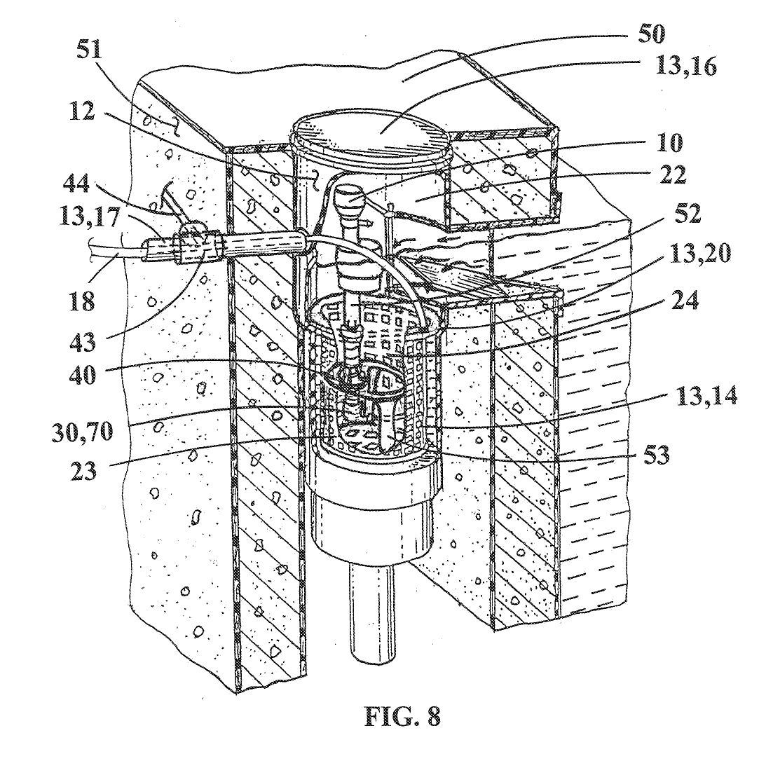

FIG. 8 is a perspective cutaway view of a pool compartment and pool compartment members interfacing with apparatus consisting of a fluid controller, a skimmer basket and a mounting pedestal, or a latitudinal mounting ring in-place of the mounting pedestal;

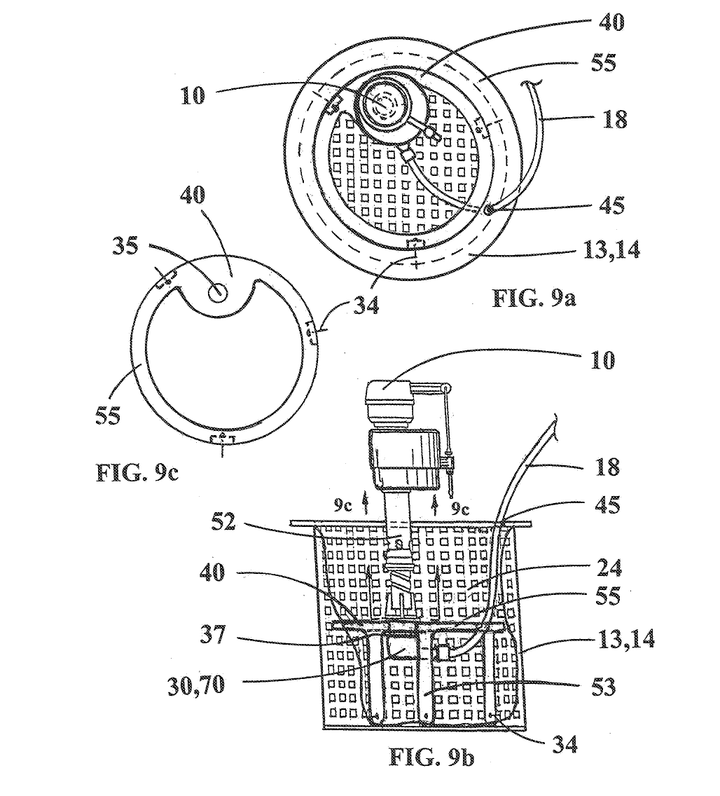

FIG. 9a is a top view showing an embodiment of FIG. 8 consisting of the fluid controller, the skimmer basket and the mounting pedestal;

FIG. 9b is a front view showing the same embodiment as in FIG. 9a;

FIG. 9c is a top view taken of line 9c-9c of FIG. 9b showing the mounting pedestal;

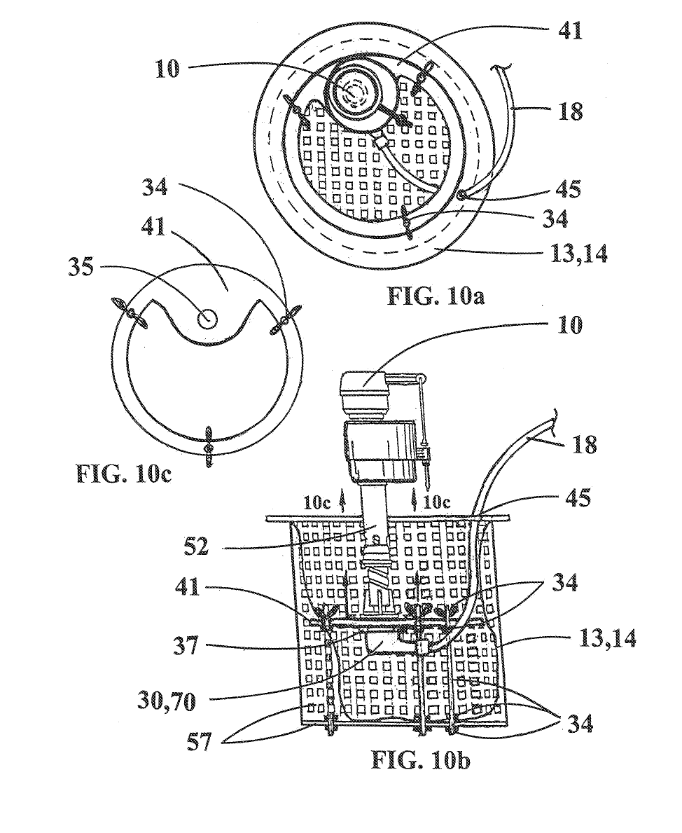

FIG. 10a is a top view showing an alternative embodiment of FIG. 8 consisting of the fluid controller, the skimmer basket and a latitudinal mounting ring, sufficiently suspended in a plurality of ways within the skimmer basket;

FIG. 10b is a front view showing the same embodiment as in FIG. 10a;

FIG. 10c is a top view taken of line 10c-10c of FIG. 10b showing the latitudinal mounting ring, sufficiently suspended in a plurality of ways within the skimmer basket;

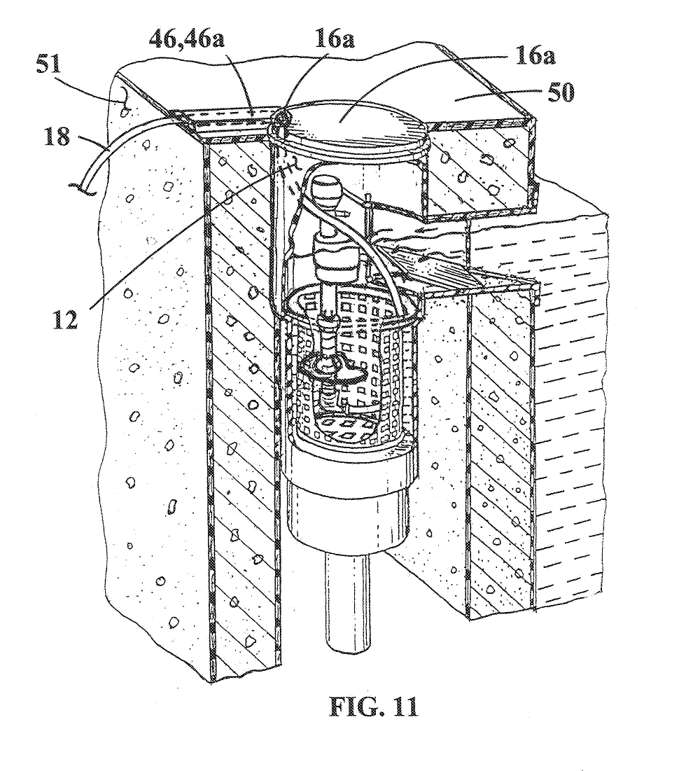

FIG. 11 is a perspective cutaway view showing the same embodiment as in FIG. 1, without a lateral water overflow tube, providing routing of the fluid supply conduit above the pool deck surface;

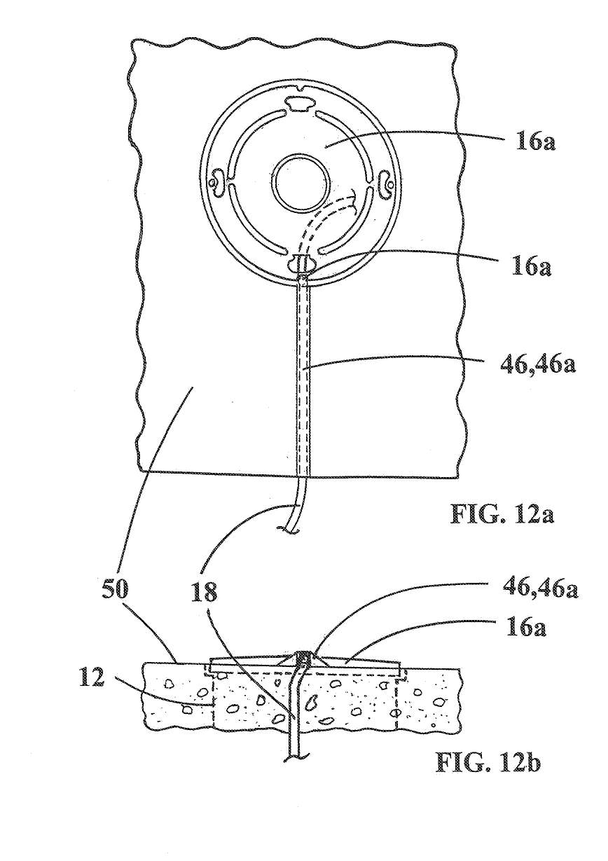

FIG. 12a is a top view showing an embodiment of FIG. 11 consisting of the pool compartment surrounded by a pool deck, and a skimmer basket access cover that is modified to facilitate routing of the fluid supply conduit above the pool deck surface;

FIG. 12b is a front view showing the same embodiment as in FIG. 12a;

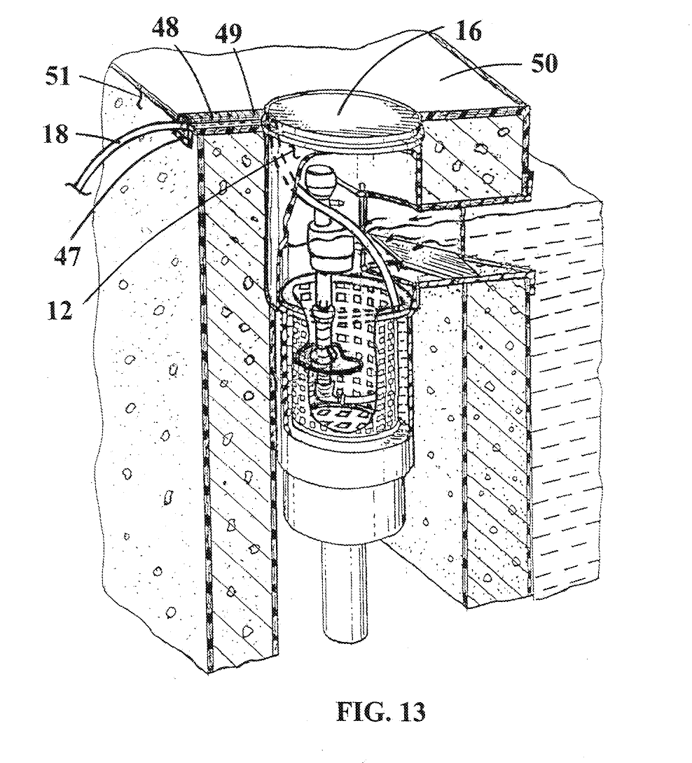

FIG. 13 is a perspective cutaway view showing the same embodiment as in FIG. 1 without a lateral water overflow tube, providing routing of the fluid supply conduit in a deck trench below the pool deck surface;

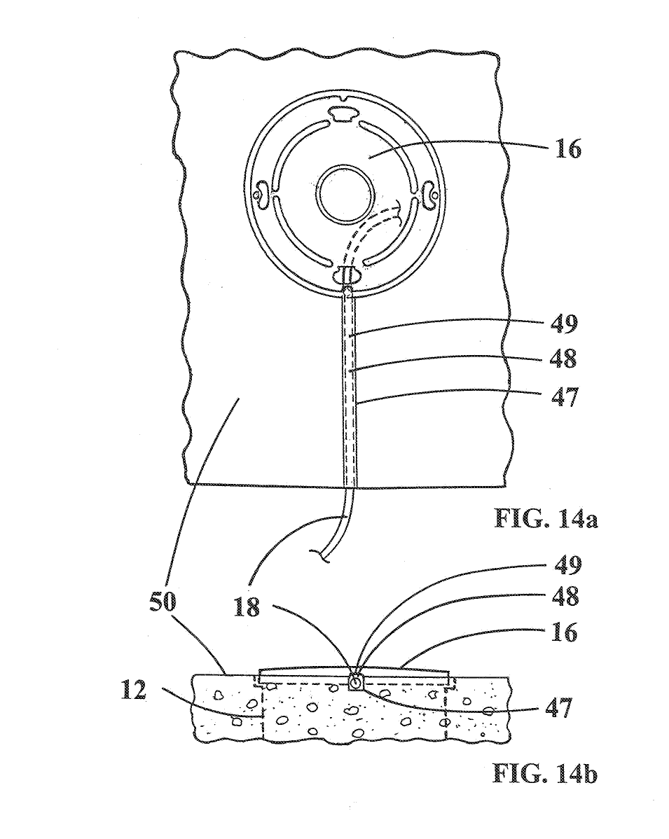

FIG. 14a is a top view showing an embodiment of FIG. 13 consisting of the pool compartment surrounded by a pool deck that is modified to facilitate routing of the fluid supply conduit in a deck trench below the pool deck surface;

FIG. 14b is a front view showing the same embodiment as in FIG. 14a;

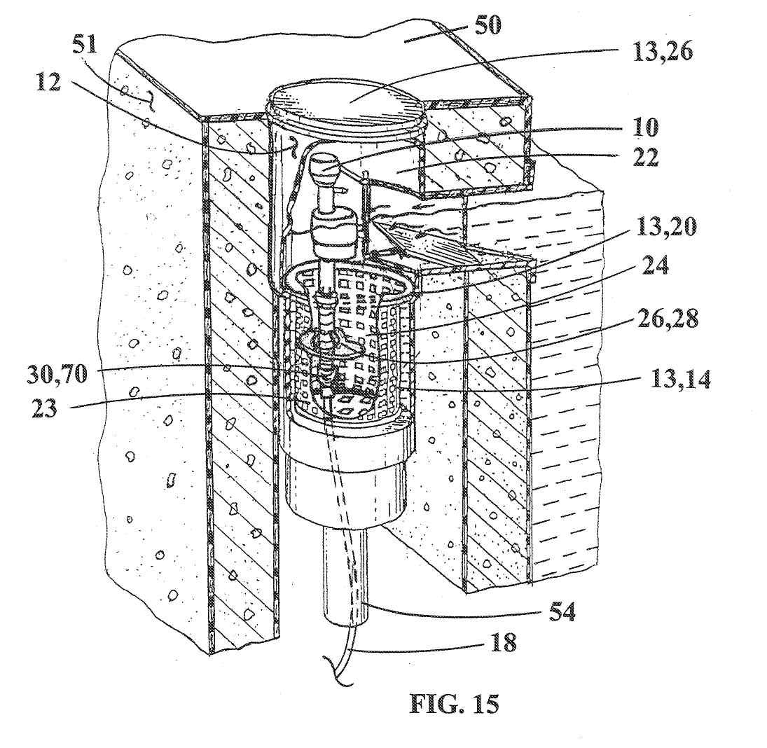

FIG. 15 is a perspective cutaway view showing the same embodiment as in FIG. 1 without a lateral water overflow tube, providing routing of the fluid supply conduit routed through the skimmer compartment water return line;

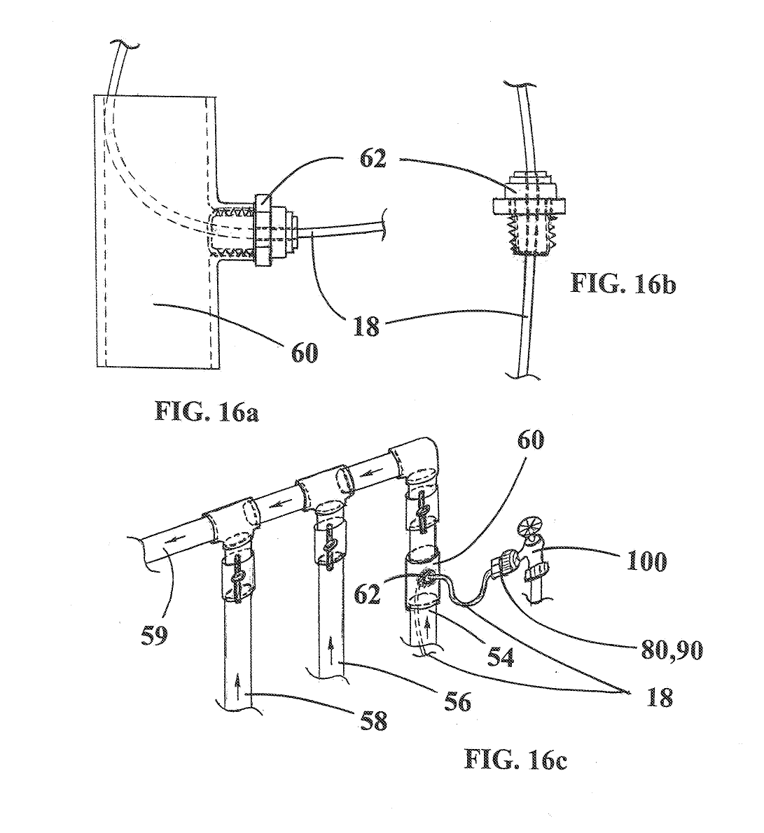

FIG. 16a is a side view showing a water return line tee or wye connector with a fluid supply conduit connector, modified to be a through-fitting for the fluid supply conduit;

FIG. 16b is a side view showing the fluid supply conduit connector, modified to be a through-fitting for the fluid supply conduit;

FIG. 16c is a perspective view showing a pool and spa horizontal water return header line with (3) vertical pool and spa water return lines. Additionally shown is the skimmer compartment water return line that is modified to include the water return line tee or wye connector, the fluid supply conduit connector modified to be a through-fitting, and the previously routed fluid supply conduit exiting and attaching to a water supply source;

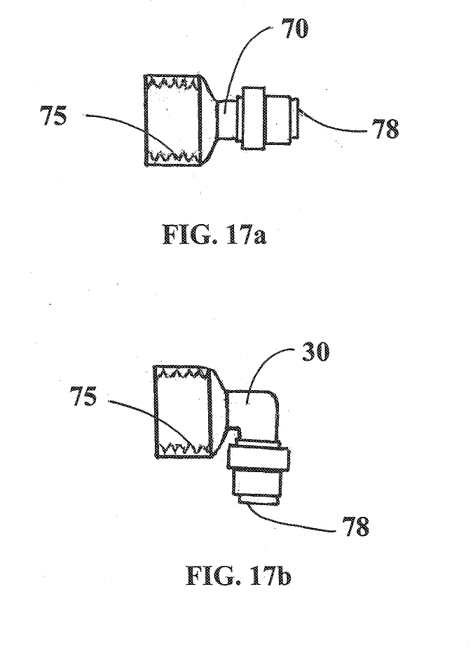

FIG. 17a is a side view showing a fill valve to fluid supply conduit, straight connector (for example: a toilet fill valve, 180 degree, ⅞″ threaded female to quick connect or push lock connector, etc.);

FIG. 17b is a side view showing a fill valve to fluid supply conduit, angular connector (for example: a toilet fill valve, 90 degree, ⅞″ threaded female to quick connect or push lock connector, etc.);

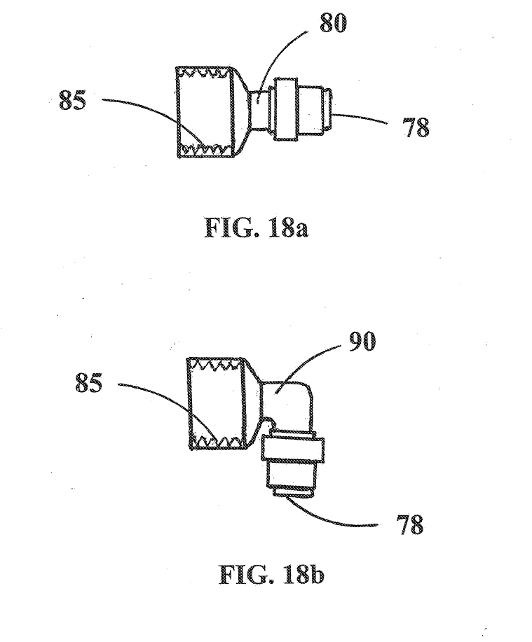

FIG. 18a is a side view showing a water supply source to fluid conduit, straight connector (for example: a bibb valve 180 degree, ¾″ garden hose threaded female to quick connect or push lock connector, etc.); and

FIG. 18b is a side view showing a water supply source to fluid conduit, angular connector (for example: a bibb valve 90 degree, ¾″ garden hose threaded female to quick connect or push lock connector, etc.)

### DRAWINGS

### Reference Numerals

10 fluid controller(s), toilet fill valve(s) or other such fluid device
12 pool compartment(s)
13 pool component(s) or compartment members(s) (for example: skimmer basket, skimmer basket access cover, latitudinal water overflow tube, pool skimmer-housing flange, etc.)
14 skimmer basket(s)
16 skimmer basket access cover
16a notched skimmer basket access cover
17 latitudinal water overflow tube(s)
18 fluid supply conduit(s)
20 pool skimmer-housing flange
22 skimmer basket chamber(s)
23 skimmer basket circumferential sidewall (or: circumferential sidewall)
24 skimmer basket volume
26 latitudinal mounting plate (separate piece)
27 latitudinal mounting plate (separate piece with bolt holes)
27a latitudinal mounting plate (separate piece with bolt holes having a fork edge)
28 latitudinal mounting plate (molded in-place)
30 fill valve to fluid supply conduit, angular connector(s) (for example: a one piece toilet fill valve, 90 degree, ⅞″ threaded female to quick connect or push lock connector, etc.)
32 skimmer basket top edge (or top edge)
34 securing mechanism(s) (for example: screws, rivets, rods, nuts, bolts, clips, clamps, snaps, washers, adhesives, pins, hinges, springs, welds, etc.)
35 latitudinal mounting hole(s) (cut-in or molded in-place)
36 spacer(s)
37 fluid controller or toilet fill valve nut
38 latitudinal flooring structure or bottom
40 mounting pedestal
41 latitudinal mounting ring
42 mounting location(s) (for example: a slot, slotted section, hole(s), etc.)
43 tee or wye conduit connector (alternate routing method)
44 fluid supply conduit(s) (alternate routing method)
45 optional fluid supply conduit routing-hole(s)
46 protective molding
46a fluid supply molding conduit
47 deck trench
48 chalking or adhesive filler
49 optional protective molding
50 pool deck
51 pool deck perimeter edge
52 adjustable tube(s)
53 fixed or adjustable vertical supporting leg(s)
54 skimmer compartment water return line
55 horizontal top ring
56 spa water return line
57 skimmer basket walls and floor
58 pool main water return line
59 horizontal water return header line
60 water return line tee or wye connector
62 fluid supply conduit connector(s), modified to be a through-fitting (for example: a modified pipe threaded fitting to a quick connect or push lock connector, etc.)
70 fill valve to fluid supply conduit, straight connector(s) (for example: a one piece toilet fill valve, 180 degree, ⅞″ threaded female to quick connect or push lock connector, etc.)
75 ⅞″ threaded female (connector end)
78 quick connect or push lock (connector end)
80 water supply source to fluid conduit, straight connector(s) (for example: a one piece bibb valve, 180 degree, ¾″ garden hose threaded female to quick connect or push lock connector, etc.)
85 ¾″ garden hose type threaded female (connector end)
90 water supply source to fluid conduit, angular connector(s) (for example: a one piece bibb valve, 90 degree, ¾″ garden hose threaded female to quick connect or push lock connector, etc.)
100 water supply source (for example: a bibb valve with a ¾″ garden hose threaded male end, etc.)
110 holder assembly
114 fluid controller or fill-valve connector(s)
118 split
120 central opening
124 clamp or clip
128 connecting beam

### DETAILED DESCRIPTION

### FIGS. 1, 2a, 2b, 2c, 17a and 17b

### First Embodiment

An embodiment for maintaining pool water levels utilizing a toilet fill valve 10 and a skimmer basket 14 is shown in FIG. 1 (perspective cutaway view). The view shows a pool compartment 12 with a skimmer basket chamber 22, housing various pool compartment members 13. Several pool compartment members 13 being a skimmer basket 14, a skimmer basket access cover 16, a pool skimmer-housing flange 20, and a latitudinal water overflow tube 17 available on many built-in, above-ground pool designs, are useful to several of the embodiments. The pool skimmer-housing flange 20 provides sufficient support for the skimmer basket 14, fixing its location within the skimmer basket chamber 22. Facilitated by an efficient design, a skimmer basket volume 24 within the skimmer basket 14, and the volume within the skimmer basket chamber 22 up to the skimmer basket access cover 16, together provides sufficient space for attaching a latitudinal mounting plate 26/28 to a skimmer basket circumferential sidewall 23 for mounting a toilet fill valve 10 with a securing fill valve nut 37. A fluid supply conduit 18 routed through the latitudinal water overflow tube 17 into the skimmer basket chamber 22, attaches to the toilet fill valve 10 by way of a toilet fill valve to a fluid supply conduit, angular or straight, connector 30/70 in order to provide water supply to replenish pool water. I contemplate that the fluid supply conduit 18 of the first embodiment be made of a small diameter flexible tube of nylon, vinyl or plastic, such as 0.25″ NBR W.P. 250# and the like, in a quick connect or push lock attaching configuration, albeit other materials, sizes, diameters, shapes, attaching configurations, etc., are also suitable. The contemplated fluid supply conduit 18 has additional benefits such as being available in sufficiently high working-pressure constructions and in ultraviolet resistant formulations for safety, and narrow profiles for ease of routing, low visibility, and the like. An alternate routing embodiment for the fluid supply conduit 18 provides a tee or wye conduit connector 43 that bisects the latitudinal water overflow tube 17 and facilitates the installation as necessary with revised routing patterns for the fluid supply conduit 44, should it become advantageous. Disclosing that the latitudinal water overflow tube 17 provides an excellent pathway for routing the fluid supply conduit 18 through the concrete of a pool deck 50 to a pool deck perimeter edge 51, it becomes evident to those familiar with the art that there is a plurality of ways to create other acceptable pathways for routing the fluid supply conduit 18 in order to provide water supply to the toilet fill valve 10. For pools not equipped with the latitudinal water overflow tube 17, alternate methods are necessary and include, albeit not limited to, creating a pathway, trench, hole, or the like, located above, below or through the pool deck 50, and inserting a tube or other such device into or onto the pathway, trench, hole, or the like, from the pool deck perimeter edge 51 to the pool compartment 12. Some alternate methods for routing the fluid supply conduit 18 are described later, and are necessary due to a wide variety of pool designs and construction methods deployed throughout the industry.

FIG. 2a (top view), FIG. 2b (front view) and FIG. 2c (sectional top view) shows three views, which detail the attachment of component parts within the first embodiment. Cutting or molding in-place a mounting location(s) (for example: a slot, slotted section, hole(s), etc.) 42 into the skimmer basket circumferential sidewall 23, modifies the skimmer basket 14. There is a plurality of acceptable lateral positions for the mounting location(s) 42 on the skimmer basket circumferential sidewall 23, ranging anywhere from top to bottom. A latitudinal mounting plate (a separate piece) 26, is inserted into the mounting location(s) 42, and joined with securing mechanisms(s) (for example: screws, rivets, rods, nuts, bolts, clips, clamps, snaps, washers, adhesives, pins, hinges, springs, welds, etc.) 34, further to be known as simply securing mechanism(s) 34. The latitudinal mounting plate 26 provides a solid mounting area for the toilet fill valve 10 when inserted into the latitudinal mounting hole 35, and secured with a fill valve nut 37. For those familiar with the art, a plurality of acceptable attaching methods exist to connect the fluid supply conduit 18, available in a plurality of conduit sizes and material constructions, to the toilet fill valve 10. An optional fluid supply conduit routing-hole 45 in the skimmer basket 14 provides improved routing and control of the fluid supply conduit 18 as required.

FIG. 17a (side view) shows a fill valve to fluid supply conduit, straight connector embodiment, and FIG. 17b (side view) shows a fill valve to fluid supply conduit, angular connector embodiment, both supported by FIGS. 1 and 2b as described above. The two connector embodiments referenced, show a solution that I contemplate to an economic and packaging problem found with the use of fluid controllers. When utilizing general fluid controllers, many of these devices are found with standard tube sizes and plumbing dimensions, such as 1″, ¾″, ½″, ¼″, etc., which allow for connectivity to a wide array of inexpensive conduit connectors, suitable for attaching to fluid supply conduit 18. Fluid controllers in general, are not sufficiently inexpensive due to somewhat low economies of scale. As a benefit, I find a family of devices within the realm of general fluid controllers, which are sufficiently less expensive due to their wider popularity and use; specifically, they are the toilet fill valves 10. The low cost of the toilet fill valve 10, although, is somewhat offset by its non-standard ⅞″ threaded tube sized (a standard toilet fill valve feature, not shown), for which there are few inexpensive connector alternatives available. The need for inexpensive ⅞″ threaded tube sized connectors, able to efficiently complete the attachment of toilet fill valves 10 to conduits of standard sizes, such as ¼″, ½″, ¾″, etc., becomes more important as one understands the following. While multiple connectors and multiple conduit sections, together, can be used successfully to attach the fluid supply conduit 18 to the ⅞″ threaded tube of toilet fill valves 10, and while such arrangements still function well in many skimmer baskets 14 and many skimmer basket chambers 22, not all pool designs, construction methods, and pool compartments 12 are the same. Many pool designs instead utilize smaller skimmer baskets 14 and smaller skimmer basket chambers 22, which sufficiently limit the available interior space. Consequently, the development and use of certain ⅞″ threaded tube sized connectors eliminate the need for awkward, bulky, multiple connectors and conduit sections, which: 1) reduces the overall manufacturing cost, 2) facilitates the routing of and reduces the complexity of the water supply conduit 18 and its connections within more confined spaces for a better package, such as in the skimmer basket 14 and skimmer basket chamber 22, and 3) allows the first embodiment's application to include many more pool designs including those with smaller skimmer baskets 14 and smaller skimmer basket chambers 22 that also require a smaller embodiment package. In this regard, I contemplate that the toilet fill valve 10, a single ⅞″ threaded tube sized connector be: 1) a fill valve to fluid supply conduit, angular connector(s) (for example: a one piece toilet fill valve, 90 degree, ⅞″ threaded female connector end 75 to quick connect or push lock connector end 78, etc.) 30, or 2) a fill valve to fluid supply conduit, straight connector(s) (for example: a one piece toilet fill valve, 180 degree, ⅞″ threaded female connector end 75 to quick connect or push lock connector end 78, etc.) 70, albeit other connectors whether being single or multiple piece(s), of any size, diameter, shape or angle, of any attaching method, of any material, and etc., are also suitable. Upon implementation of the contemplated fill valve to fluid supply conduit, angular and straight connector embodiments, and in consideration for the various larger or smaller sizes of skimmer baskets 14 and skimmer basket chambers 22, the first embodiment will benefit greatly from a better package, wider application, higher efficiency of conduit routing, ease of installation and servicing, and reduced cost of labor and materials.

### Operation

### FIGS. 1, 2a, 2b, 2c, 17a and 17b

### First Embodiment

Based on geographical location, construction method, physical size, manufacturer and components selected, pools, spas, and the like, vary greatly across the industry. Similarly, the designs of skimmer baskets 14 and skimmer basket chambers 22 vary widely. These facts necessitate that additional and alternate embodiments be created, each being capable of maintaining pool water levels. As the embodiments are described, it will become obvious that the functional and operational differences between them are sufficiently minor and easily understood by those skilled in the art. With this understanding, the first embodiment's operation will be described in detail, with the additional and alternate embodiment's operation described more briefly, highlighting only the important differences.

While fluid controllers function in a sufficiently similar manner, the operation of the toilet fill valve 10 of the first embodiment is similar to that found within a conventional toilet tank for water control. The skimmer basket 14 of the first embodiment, whose normal pool function is to trap surface debris, is modified to include a latitudinal mounting plate 26, on which the toilet fill valve 10 is mounted. The skimmer basket 14 is lowered into the pool compartment 12 and rests in a fixed position on the pool skimmer-housing flange 20. This sufficiently positions the toilet fill valve 10 within the skimmer basket 14 to be in proper communication with the pool water. The toilet fill valve 10 can be adjusted in height to a plurality of desirable settings, similar to the method used within a toilet tank, in order to raise or lower the pool water. Should the pool water level fall sufficiently below the desired water level setting, additional water is added by way of the toilet fill valve 10 opening and allowing new water to flow from the fluid supply conduit 18 into the base of the toilet fill valve 10 by way of the fill valve to fluid supply conduit, angular or straight connector 30/70. In many built-in, above-ground pool applications, excess water from rain and other sources is removed from the pool by way of the lateral water overflow tube 17, which is attached to the pool compartment 12 and is in communication with pool water. The latitudinal water overflow tube 17 provides an excellent port of entry into the pool compartment 12 from outside of the pool for the routing of the fluid supply conduit 18 from the toilet fill valve 10 to a reliable public or private fresh water supply. By utilizing methods familiar to those in the art, water can be plumbed from either a hard waterline or an outdoor bibb valve (common garden faucet—not shown) to the fluid supply conduit 18. Routing the fluid supply conduit 18 through the latitudinal water overflow tube 17 into the pool compartment 12, and connecting it to the toilet fill valve 10, sufficiently completes the water transmission pathway. An optional fluid supply conduit routing-hole 45 in the skimmer basket 14 provides improved routing and control of the fluid supply conduit 18, thereby reducing the risk of interfering with the operation of the toilet fill valve 10, if required. While many acceptable fluid supply conduit(s) 18 are available, certain types, such as a 0.25″ NBR 250# W.P., quick connect or push lock or similar configuration conduit, have properties that provide a sufficiently safe, high working-pressure limit, ultraviolet radiation protection, a very narrow profile, ease of routing, ease of connecting, and a low visibility option for a fluid supply conduit choice. The features and properties of this type of fluid supply conduit also allow for it to be easily mounted to the sides of pool-cage structures, hidden in or by landscape, or buried underground for an overall improvement in appearance, ease of installation and serviceability.

### FIGS. 1, 3a, 3b and 3c

### Alternate Embodiment

An alternate embodiment of FIG. 1 is shown in drawings FIG. 3c (top view), FIG. 3b (front view) and FIG. 3c (sectional top view), consisting of a skimmer basket 14 that is modified by integrating a latitudinal mounting plate (molded in-place) 28 into the circumferential sidewall 23 in a plurality of acceptable positions, during the basket molding process, to which the toilet fill valve 10 is mounted and secured with a fill valve nut 37. Integrally molding the latitudinal mounting plate 28 into the skimmer basket 14 sufficiently reduces the quantity of parts and the amount of labor as compared to the first embodiment, so to further streamline the process and reduce cost. These are the major differences as compared to the first embodiment of FIG. 1, at which point the description and operation of both becomes sufficiently alike. While product simplification and cost reduction exists with the alternate embodiment as described previously, these benefits are not the sole reason for this embodiment. The wide variety of pool compartment 12 and skimmer basket 14 sizes and shapes requires the development of the additional alternative embodiments like the one described to more broadly cover the wide variety of pool components 13 found within the pool industry.

### FIGS. 4, 5a, 5b, 5c, 5ca, 5cb, 5d, 5e and 5f

### Alternate Embodiments

FIGS. 4 (perspective cutaway view), 5a (top view), 5b (side view) and 5c (sectional top view) show two alternate embodiments consisting of a skimmer basket 14 with a latitudinal mounting plate (separate piece with bolt holes) 27 affixed to a skimmer basket top edge 32 with securing mechanisms 34, to which the toilet fill valve 10 is mounted and secured with a fill valve nut 37. FIG. 5ca (side view) shows the latitudinal mounting plate 27 as a flat plate with a flat edge, and alternately FIG. 5cb (side sectional view) shows the latitudinal mounting plate 27a as a flat plate with a forked edge, both types sufficiently useful for mounting the toilet fill valve 10 utilizing securing mechanisms 34. Securing mechanisms 34, such as hinges and springs are particularly effective with the latitudinal mounting plate 27. These are the major differences as compared to the first embodiment of FIG. 1, at which point the description and operation of both becomes sufficiently alike. As previously described, the wide variety of pool compartment 12 and skimmer basket 14 sizes and shapes requires the development of the additional alternative embodiments like the one described to more broadly cover the wide variety of pool components 13 found within the pool industry.

### FIGS. 4, 5d, 5e and 5f

### Alternate Embodiment

An alternate embodiment of FIG. 4 is shown in drawings FIG. 5d (top view), FIG. 5e (front view), and FIG. 5f (sectional top view), consisting of a skimmer basket 14 that is modified by integrating a latitudinal mounting plate (molded in-place) 28 into the skimmer basket top edge 32 in a plurality of acceptable positions, during the basket molding process, to which the toilet fill valve 10 is mounted and secured with a fill valve nut 37. Integrally molding the latitudinal mounting plate 28 into the skimmer basket 14 sufficiently reduces the quantity of parts and the amount of labor as compared to the first embodiment, so to further streamline the process and reduce cost. These are the major differences as compared to the first embodiment of FIG. 1, at which point the description and operation of both becomes sufficiently alike. While product simplification and cost reduction exists with the alternate embodiment as described previously, these benefits are not the sole reason for this embodiment. The wide variety of pool compartment 12 and skimmer basket 14 sizes and shapes requires the development of the additional alternative embodiments like the one described to more broadly cover the wide variety of pool components 13 found within the pool industry.

### FIGS. 4, 5g, 5h, 5i and 5j

### Alternate Embodiment

An alternate embodiment of FIG. 4 is shown in drawings FIG. 5g (top view), FIG. 5h (front view), FIG. 5i (component top view) and FIG. 5j (component side view), consisting of the toilet fill valve 10 and the skimmer basket 14 connected together by a holder assembly 110. The holder assembly 110 consists of: 1) a first end that is a clamp or a clip 124 or other such device capable of attaching to the skimmer basket 14 in a plurality of acceptable positions with securing mechanisms 34 as required, 2) a second end that is a fluid controller or fill-valve connector 114 capable of mounting and positioning the toilet fill valve 10 with securing mechanisms 34 as required, and 3) a connecting beam 128, which attaches the first and second ends of the holder assembly 110 together. The second end, which is the fluid controller or fill-valve connector 114 of the holder assembly 110 also, has a central opening 120 and a split 118 to facilitate mounting to the adjustable tubes 52 of the toilet fill valve 10. These are the major differences as compared to the first embodiment of FIG. 1, at which point the description and operation of both becomes sufficiently alike. The wide variety of pool compartment 12 and skimmer basket 14 sizes and shapes requires the development of the additional alternative embodiments like the one described to more broadly cover the wide variety of pool components 13 found within the pool industry.

### FIGS. 6, 7a, 7b and 7c

### Alternate Embodiment

FIGS. 6 (perspective cutaway view), 7a (top view), 7b (side view) and 7c (sectional top view) show two alternate embodiments consisting of: 1) a first skimmer basket 14 modified with a latitudinal mounting hole cut-in 35, and 2) a second skimmer basket 14 modified with a latitudinal mounting hole molded in-place 35, both located in the latitudinal flooring structure or bottom 38, in a plurality of acceptable positions, to which the toilet fill valve 10 is mounted and secured with a fill valve nut 37. The two alternate embodiments may also utilize somewhat different optional fluid supply conduit routing-holes 45 within the skimmer basket 14 as shown in FIG. 7b. For a sufficiently tall skimmer basket utilizing this embodiment, a spacer 36 is provided to create extra height for improved adjustability of the toilet fill valve 10. These are the major differences as compared to the first embodiment of FIG. 1, at which point the description and operation of both becomes sufficiently alike. While product simplification and cost reduction exists with the alternate embodiment as described previously, these benefits are not the sole reason for this embodiment. The wide variety of pool compartment 12 and skimmer basket 14 sizes and shapes requires the development of the additional alternative embodiments like the one described to more broadly cover the wide variety of pool components 13 found within the pool industry.

### FIGS. 8, 9a, 9b, 9c, 10a, 10b and 10c

### Alternate Embodiments

FIGS. 8 (perspective cutaway view), 9a (top view), 9b (side view) and 9c (sectional top view) show an alternate embodiment consisting of a mounting pedestal 40 with a built-in, latitudinal mounting hole 35, to which the toilet fill valve 10 is mounted and secured with a fill valve nut 37. The mounting pedestal 40, having a drop-in feature useful when used with a skimmer basket 14, effectively facilitates installation and maintenance, and is sufficiently self-contained. The mounting pedestal 40, having fixed or adjustable vertical supporting legs 53 depending upon the application, facilitates the placement of the toilet fill valve 10 accurately within the pool compartment 12, which is in communication with pool water, but which may or may not utilize a skimmer basket 14. The fixed or adjustable vertical supporting legs 53 may be molded or tooled in-place as one piece with the horizontal top ring 55 whereby forming the mounting pedestal 40, or made separately and joined to the horizontal top ring 55 by way of subsequent manufacturing operations. Optional securing mechanisms 34 may be used to attach the mounting pedestal 40 to the pool compartment 12, to the skimmer basket 14, or to both in order to reduce pedestal movement as required, utilizing a plurality of attaching methods familiar to those in the art.

An alternate embodiment of FIG. 8 is shown in drawings FIG. 10a (top view), FIG. 10b (front view) and FIG. 10c (component top view). While similar to the mounting pedestal 40 of the prior embodiment, this alternate embodiment provides a latitudinal mounting ring 41 with a built-in latitudinal mounting hole 35 to which the toilet fill valve 10 is mounted and secured with a fill valve nut 37. Securing mechanisms 34 or the like are used to attach the mounting ring 41 to the skimmer basket 14 utilizing a plurality of attaching methods familiar to those in the art. The skimmer basket walls and floor 57 provide an effective surface for mounting the latitudinal mounting ring 41 with the securing mechanisms 34 either vertically (shown), diagonally (not shown), or horizontally (not shown), in a plurality of acceptable mounting positions. Additionally as another alternate embodiment, the latitudinal mounting ring 41 with securing mechanisms 34 also has sufficient capability for effectively mounting the toilet fill valve 10 to the underside of the skimmer basket access cover 16, while maintaining a sufficiently correct position and communication with pool water. These are the major differences as described of the alternate embodiments of FIG. 8, as compared to the first embodiment of FIG. 1, at which point the description and operation of both becomes sufficiently alike. The wide variety of pool compartment 12 and skimmer basket 14 sizes and shapes requires the development of the additional alternative embodiments like the ones described to more broadly cover the wide variety of pool components 13 found within the pool industry.

### FIGS. 11,12a and 12b

### Alternate Embodiments for Fluid Supply Conduit Routing

Built-in pools and spas, constructed with a surrounding pool deck 50, generally fall into two categories: above-ground and in-ground pool designs. So far, the preceding embodiments have described a routing method for the fluid supply conduit 18 through the latitudinal water overflow tube 17, as long as one existed. Above-ground pool designs are primarily, but not exclusively, found in flood-prone and/or generally sufficiently rainy regions, where excessive pool water can accumulate. In more arid regions, where excess pool water is less of a concern, or in in-ground pool designs where often the latitudinal water overflow tube 17 is missing, alternate routing methods for the fluid supply conduit 18 is desirable and will follow.

FIG. 11 (perspective cutaway view) shows an alternate embodiment for routing a fluid supply conduit 18 that is somewhat similar to the first embodiment in FIG. 1, but without having a lateral water overflow tube 17 that provides a routing pathway for the fluid supply conduit 18 below the pool deck 50. FIG. 11 together with FIGS. 12a (top view) and 12b (side view) further describes the alternative embodiment consisting of the pool compartment 12 surrounded by a pool deck 50, and a notched skimmer basket access cover 16a so modified to facilitate routing of the fluid supply conduit 18 above the pool deck 50. As the fluid supply conduit 18 exits upward from the pool compartment 12 through the notched skimmer basket access cover 16a, it rests latitudinally on the surface of the pool deck 50. While able to function without it, a protective molding 46 can be utilized to protect the fluid supply conduit 18 from damage, and to protect humans with added measures of safety by better controlling the fluid supply conduit 18. Both the fluid supply conduit 18 and the protective molding 46 can be extended in length to sufficiently traverse the pool deck 50 to a pool deck perimeter edge 51, or other such area, at which point the routing of the fluid supply conduit 18 becomes sufficiently similar to that which was described in the first embodiment of FIG. 1. The protective molding 46 can be made of any material and in any profile, but I contemplate that the molding be made in a sufficiently low profile, and constructed for strength and safety. While not mandatory, optimum control of the protective molding 46 can be attained by utilizing securing mechanisms 34, such as adhesives and the like, to attach the protective molding 46 to the pool deck 50. Additionally, as another alternate embodiment, the protective molding 46 can itself be designed so to function as a fluid supply molding conduit 46a, making it possible to couple with regular fluid supply conduit 18, previously described, for routing above the pool deck 50. There is a plurality of routing methods familiar to those in the art that will become obvious upon review of the embodiments described in this writing.

### FIGS. 13,14a and 14b

### Alternate Embodiments for Fluid Supply Conduit Routing

FIGS. 13 (perspective cutaway view), 14a (top view) and 14b (side view) show another alternate embodiment for routing a fluid supply conduit 18, which is similar to the alternative embodiment in FIG. 11, but instead of routing the fluid supply conduit 18 above the pool deck 50, the routing is within the pool deck 50. The method of this embodiment sufficiently directs the fluid supply conduit 18 out of the pool compartment 12 and upward into a deck trench 47. Low profile, low depth trenching of the pool deck 50 and notching of the upper edge of the pool compartment 12, utilizing a plurality of cutting methods familiar to those in the art, sufficiently creates the deck trench 47. Beginning inside of the pool compartment 12 below the skimmer basket access cover 16, the deck trench 47 continues latitudinally below the surface of the pool deck 50 to a pool deck perimeter edge 51. The fluid supply conduit 18 is positioned into the deck trench 47, where it continues latitudinally for the complete length of the deck trench 47 where it exits beyond the pool deck perimeter edge 51. Chalking or adhesive filler 48, and/or an optional protective molding 49, sufficiently covers and secures the fluid supply conduit 18 within the deck trench 47, sufficiently below the surface of the pool deck 50. Exiting the deck trench 47 beyond the pool deck perimeter edge 51, positions the fluid supply conduit 18 to a point at which the method of further routing of the fluid supply conduit 18 becomes sufficiently similar to that which was described in the first embodiment of FIG. 1. While the protective molding 46 can be made of any material and in any profile, I contemplate that it be manufactured in a sufficiently low profile for safety and constructed for strength. While not mandatory, optimum control of the protective molding 46 on the pool deck 50 can be achieved by utilizing securing mechanisms 34, such as adhesives and the like, to attach the protective molding 46 to the pool deck 50. Other alternate methods for routing fluid supply conduit 18 can also involve drilling a latitudinal hole through the pool deck 50 (not shown), etc. There is a plurality of alternate routing methods familiar to those in the art that will become obvious upon review of the embodiments described in this writing.

### FIGS. 15, 16a,16b,16c,18a and 18b

### Alternate Embodiments for Fluid Supply Conduit Routing

FIG. 15 (perspective cutaway view) shows an alternate embodiment for routing a fluid supply conduit 18 that is somewhat similar to the first embodiment in FIG. 1, but without having a lateral water overflow tube 17 that provides a routing pathway for the fluid supply conduit 18 below the pool deck 50. FIG. 15 together with 16a (connector and through-fitting side view), 16b (through-fitting side view) and 16c (modified pool and spa return lines perspective view) further show the alternative embodiment and method consisting of the fluid supply conduit 18 exiting the skimmer basket 14 into the lower section of the pool compartment 12. A skimmer compartment water return line 54 attached to the lower section of the pool compartment 12 provides a sufficiently large routing conduit for the fluid supply conduit 18 to be routed through in order to locate and attach to a water supply source 100. The method of FIGS. 16a, 16b, and 16c shows the skimmer compartment water return line 54 that has been modified by bisecting and coupling together with a water return line tee or wye connector 60. In these regards, I contemplate that the water return line tee or wye connector 60 provides sufficient capability for attaching to fluid supply conduit connector(s), modified to be a through-fitting (for example: a modified pipe threaded fitting to a quick connect or push lock connector, etc.) 62, and allowing the fluid supply conduit 18 to effectively exit outside of the water return line tee or wye connector 60 without leaking. Once outside of the skimmer compartment water return line 54, the fluid supply conduit 18 can be sufficiently extended to be in close proximity to a water supply source 100. There is a plurality of acceptable water conduit connecting methods familiar to those in the art that will become obvious upon review of the embodiments described in this writing. In these regards, I contemplate that the fluid supply conduit 18 can be connected to the water supply source (for example: a bibb valve with a ¾″ garden hose threaded male end, etc.) 100 with a water conduit connector being: 1) a water supply source to fluid conduit, straight connector(s) (for example: a one piece bibb valve, 180 degree, ¾″ garden hose threaded female connector end 85 to quick connect or push lock connector end 78, etc.) 80, or 2) a water supply source to fluid conduit, angular connector(s) (for example: a one piece bibb valve, 90 degree, ¾″ garden hose threaded female connector end 85 to quick connect or push lock connector end 78, etc.) 90, albeit other connectors whether of single or multiple piece(s), of any size, diameter, shape or angle, of any attaching method, of any material, and etc., are also suitable.

### FIGS. 4 and 5b

### Alternate Toilet Fill Valve Embodiment

In general, selecting one of the many skimmer basket embodiments already mentioned will provide an effective solution for maintaining pool water levels in a plurality of pool styles and a plurality of skimmer basket sizes and shapes available in the industry. Alternatively, an embodiment exists for scenarios where limited space may still inhibit one of the many embodiments already mentioned from performing sufficiently well. FIGS. 4 and 5b shows an earlier embodiment where sufficient space could be lacking in certain pool applications. Consequently, an alternate toilet fill valve embodiment (not shown) is created that includes the option to sufficiently shorten the adjustable tubes 52 of the toilet fill valve 10, utilizing methods familiar to those in the art. The shortened fill valve effectively provides improved fitment in the sufficiently small skimmer basket (not shown), and/or the sufficiently small pool compartment (not shown) applications known to exist.

### CONCLUSION, RAMIFICATIONS, AND SCOPE

The need for a better pool water replenishment system that offers a simple, safe, effective, low cost installation and sufficiently maintenance free operation is known by pool owners. The desirable benefits described are in fact advantages of my method and apparatus, sufficiently providing:
(a) a low cost alternative to expensive automatic pool filler systems that are built-in during initial pool construction, and that require a separate pool compartment with dedicated plumbing for water supply and a dedicated water signal tube in communication with pool water,
(b) a better alternative for monitoring water levels and replenishing water in pools, which were not initially equipped with automatic pool fillers during pool construction,
(c) a safe alternative to the after-market, removable, automatic pool filler systems that require the device to be hung over the pool edge and attached to a garden hose that is laid dangerously across the pool deck, both providing a trip and fall risk to humans,
(d) a convenient “continuous-use” alternative to the after-market, removable, automatic pool filler systems, who's manufacturers warn to limit their device's use to when humans are not using the pool deck area because of the risk of trip and fall accidents, and recommending instead to store the device until the pool deck area is not in use by humans,
(e) a “low risk of burst” water supply conduit alternative, benefitting from “sufficiently high rated working-pressure” construction and “ultraviolet light protection”, as compared to a garden hose having a “low rated working-pressure” construction, lying on the pool deck, exposed to high levels of heat and sunlight when in use, and needed for water supply by the after-market, removable, automatic pool filler systems,
(f) a better alternative to the risk of very expensive water bills, should an unattended garden hose soften and burst,
(g) an improvement in appearance by effectively being “out of sight” when in use, as compared to the after-market, removable, automatic pool filler systems that require the device to be hung over the pool edge, and attached to a garden hose that is laid across the pool deck for water supply,
(h) a stable automatic pool filler system that is minimally effected by wave action when the pool is in use, as compared to the after-market, removable, automatic pool filler systems that requires the purchaser provide “stones” for ballast and increased stability, albeit without significant improvement, and still being significantly affected by wave action, and
(i) a better “burn-out” protection system for pool pump motors designed for sufficiently continuous-use and by utilizing industry components with proven reliability, as compared to the after-market, removable, automatic pool filler systems that recommend removal when humans are using the pool deck area.

Thus the reader will see that at least one embodiment of my method and apparatus for maintaining pool water levels utilizing fluid controllers and skimmer baskets, provides meaningful solutions for present and future pool and spa owners.

While the above descriptions contain much specificity, they should not be construed as limitations on the scope, but rather as an exemplification of one or more preferred embodiment(s) thereof. It is clear that many other variations are possible. For example, the alternate toilet fill valve embodiment which is described to be shortened provides less specific detail and only referenced drawings to describe the valve embodiment that has been modified and referenced but not actually shown in FIGS. 4 and 5b. Similarly, many alternate fluid controllers, which are not toilet fill valves, exist and are very acceptable devices although not described in this writing. Similarly, many bodies of fluid, which may not be pools or spas, or which may not consist of water, could have also been described in detail and would have benefitted from my method and apparatus, or their similarities. Similarly, the fluid controller could be attached, or could grip, to the sides of the pool compartment, or to the bottom side of the skimmer basket access cover. Similarly, instead of manufacturing and commercializing any of the embodiments described, it would become obvious to those familiar in the art that upon review of the embodiments of this writing, that they would be able to create the instructions for how to make the embodiments, or their likenesses, so to be sold as tutorials and instructions for the handyman or the consumer's use.

Accordingly, the scope should be determined not by the embodiments illustrated, but by the appended claims and their legal equivalents.

I claim:

1. A method for maintaining water levels within a pool, comprising:
a) providing a fluid controller comprising a toilet fill valve or other such fluid device wherein having sufficient means for fluid control,
b) providing a pool compartment wherein having a first means for sufficiently attaching and a second means for sufficiently locating pool components, and wherein having a third means for sufficiently communicating with pool water,
c) providing fluid supply conduits wherein sufficiently having means for fluid transmission, and
d) providing routing methods for said fluid supply conduits.

2. The method of claim 1 wherein said pool components, comprising:
a) providing a skimmer basket or other such basket-like device wherein having sufficient means for filtration of said pool water,
b) providing a pool skimmer housing flange wherein sufficiently having a first means for supporting and a second means for locating said skimmer basket to a defined position,
wherein said housing flange locating said skimmer basket to a defined position, together, having sufficient means for said skimmer basket to be in proper communication with a plurality of water levels within said pool,
c) providing a latitudinal water overflow tube or other such device, wherein sufficiently having a first means for communicating with said pool compartment and said pool water, and having a second means for sufficiently evacuating excess pool water from said pool, unless said pool compartment is of the type that does not incorporate said latitudinal water overflow tube or other such device, and
d) providing a skimmer basket access cover or other such device, wherein sufficiently having means for accessing said pool components.

3. The method of claim 2 wherein providing said skimmer basket comprising a top edge, a circumferential sidewall, a latitudinal flooring structure, and a skimmer basket volume, further including:
a) providing securing mechanisms, as required,
b) providing a latitudinal mounting plate or other such device, comprising a sufficiently flat horizontal surface of rigid material with a slot or hole internally located,
c) alternatively, providing a latitudinal mounting hole or other such opening, sufficiently machined into a latitudinal flooring structure of said skimmer basket and sufficiently located in a plurality of acceptable mounting positions,
d) alternatively, providing a mounting pedestal or pedestal-like device, comprising:
a. providing a sufficiently flat surface of rigid material of sufficient size having a central opening and a slot or hole in said flat surface for mounting,
b. providing a plurality of elongated support members of sufficiently equal length, and
c. joining together as an assembly, or molding together as one piece, said elongated support members at sufficiently right angles to said flat horizontal surface of said rigid material, so as to be able to sufficiently support said surface horizontally,
e) alternatively, providing a mounting ring or ring-like structure, comprising:
a. providing a sufficiently flat surface of rigid material of sufficient size having a central opening and a slot or hole in said flat surface for mounting,
b. providing a plurality of said securing mechanisms, used as elongated support members, and
c. joining together as an assembly said securing mechanisms, used as said elongated support members, to said flat surface of said rigid material utilizing a plurality of methods, so as to be able to support said flat surface of said sufficiently rigid material horizontally, and
f) alternately, providing a holder assembly or similar device for mounting said fluid controller, comprising:
a. providing a fluid controller connector of sufficiently rigid material and sufficient size, which may be split, having a central opening,
b. providing a clamp or similar device, of sufficiently rigid material and of sufficient size, having a gripping and attaching capacity in a plurality of sufficiently acceptable ways,
c. providing an elongated connecting beam, which on one end attaches said fluid controller connector and to the other end attaches said clamp,
d. providing a plurality of said securing mechanisms, used to facilitate attachments, and
e. aligning and joining together said fluid controller connector to one end of said elongated connecting beam and said clamp to an opposite end of said elongated connecting beam, using securing mechanisms as required, which together providing said holder assembly.

4. The method of claim 3 wherein providing said skimmer basket having said circumferential sidewall modified by machining a mounting location in a plurality of acceptable longitudinal positions from top to bottom, further including:
a) aligning and joining said latitudinal mounting plate to said mounting location, and attaching with said securing mechanisms, and
whereby said skimmer basket and said mounting plate joined together having means for effectively mounting said toilet fill valve or other such fluid device.

5. The method of claim 3 wherein providing said skimmer basket having said circumferential sidewall modified by integrally molding in-place a latitudinal mounting plate in a plurality of acceptable longitudinal positions from top to bottom, and comprising a sufficiently flat horizontal surface of rigid material with a slot or hole internally located, whereby said skimmer basket with said latitudinal mounting plate integrally molded in-place having means for effectively mounting said toilet fill valve or other such fluid device.

6. The method of claim 3 wherein providing said skimmer basket having said latitudinal mounting hole or other such opening, sufficiently machined into said latitudinal flooring structure, and sufficiently located in a plurality of acceptable mounting positions, whereby said skimmer basket with said latitudinal mounting hole together having means for effectively mounting said toilet fill valve or other such fluid device.

7. The method of claim 3 wherein providing said skimmer basket having said skimmer basket volume, and providing said mounting pedestal having elongated support members, wherein together sufficiently having a first means for docking and a second means for locating said mounting pedestal inside of said skimmer basket volume, with or without utilizing said securing mechanisms, whereby said skimmer basket with said mounting pedestal docked and located inside of said skimmer basket volume, together having means for effectively mounting said toilet fill valve or other such fluid device.

8. The method of claim 3 wherein providing said skimmer basket having said skimmer basket volume, further including:
a) providing said mounting ring with said flat surface of said rigid material, having said slot or hole for mounting,
b) providing said securing mechanisms, used as elongated support members, and
c) acting together as an assembly having a first means for supporting and having a second means for mounting,
thereby said skimmer basket and said mounting ring with said elongated support members wherein having sufficient means for docking and locating inside of said skimmer basket volume, and
whereby said skimmer basket with said mounting ring and said elongated support members, docked and located inside of said skimmer basket volume, together having means for effectively mounting said toilet fill valve or other such fluid device.

9. The method of claim 3 wherein said skimmer basket sufficiently having a first means for being in communication with a plurality of water levels within said pool, and having a second means for effectively mounting said toilet fill valve or other such fluid device, whereby causing said toilet fill valve or other such device to also be in communication with said plurality of water levels within said pool.

10. The method of claim 3 wherein providing said holder assembly, comprising:
a. providing said clamp having means for effectively attaching said holder assembly to said skimmer basket in a plurality of acceptable positions with said securing mechanisms,
b. providing said fluid controller connector having means for effectively attaching said holder assembly to said toilet fill valve or other such fluid device in a plurality of acceptable positions with said securing mechanisms, and
whereby said skimmer basket with said fluid controller connector together sufficiently having a first means for effectively mounting said toilet fill valve or other such fluid device, and sufficiently having a second means for effectively being in proper communication with a plurality of water levels within said pool.

11. The method of claim 1 wherein said fluid supply conduits, comprising:
a) providing a composition comprised of a plurality of materials and sizes, and a type that is elongated and has a longitudinal through-hole, wherein having sufficient means for said fluid transmission,
b) providing fluid supply conduit connectors comprised of a plurality of acceptable materials, shapes and sizes, and of a type having a longitudinal through-hole, wherein sufficiently having a first means for coupling multiple fluid supply conduits and having a second means for said fluid transmission,
c) providing said fluid conduit connectors wherein having means for coupling said fluid supply conduits that are elongated to said fluid controller comprising said toilet fill valve, or other such device,
d) providing a fluid supply source, such as a public water utility, wherein having means for said fluid transmission to a point of fluid availability, such as a residential plumbing system,
e) providing said fluid conduit connectors wherein having means for coupling said fluid supply conduits that are elongated to a point of fluid availability, such as a residential plumbing system, and
whereby said fluid controller, such as said toilet fill valve, sufficiently having means for connecting to said fluid supply source, such as said public utility, thereby effectively providing fluid to said fluid controller.

12. The method of claim 1 wherein said routing methods for said fluid supply conduits, comprising:
a) providing a plurality of said routing methods for said fluid conduits being necessary due to:
a plurality of pool elevations, such as above or below ground,
a plurality of pool types, such as swimming pool or spa,
a plurality of said pool compartments, of said pool components, and of the designs and sizes of said skimmer baskets,
said plurality of said sizes of said skimmer baskets having a corresponding plurality of said skimmer basket volumes, ranging from sufficiently large to sufficiently small,
a need for safe operation while humans use said pool,
a need for good appearance,
b) providing a plurality of moldings and other materials, in a plurality of compositions, sizes and shapes sufficiently useful to assist in said routing methods, and to improve safety and appearance, and
whereby said plurality of said routing methods for said fluid conduits, and said plurality of moldings and other materials, together having means for effectively routing said fluid supply conduits in a sufficiently safe manner and with good appearance.
